(19) United States
(12) Patent Application Publication
(10) Pub. No.: US 2004/0249324 A1
(43) Pub. Date: Dec. 9, 2004

(54) Massage tool for applying localized pressure

(76) Inventor: John Louis, Northfield, IL (US)

Correspondence Address: Lawrence J. Chapa, 1220 St. William Drive, Libertyville, IL, 60048, US

(21) Appl. No.: 10/454,378

(22) Filed: Jun. 4, 2003

(51) Int. Cl. A61H 7/00

(52) U.S. Cl. 601/135

(57) ABSTRACT

A massage tool is provided, which allows the more effective application of force, by providing a handle, which when gripped by a hand results in an axis along which force is applied that is more closely in line with the arm of the person applying the force. This allows a greater number of muscle groupings to produce and/or more effectively contribute to the generation and application of localized pressure to the intended recipient of the therapy.

### FIELD OF THE INVENTION

The invention pertains to a massage tool, and more specifically a massage tool for applying a localized force and/or pressure to the person receiving treatment.

### BACKGROUND OF THE INVENTION

Therapists apply various techniques when treating an individual, dependant upon the condition of the individual. Some techniques can require persistant application, which can be quite taxing on a therapist, especially therapists who provide treatment generally unassisted.

Some therapists have made use of various tools designed to more effectively and/or more easily apply various therapeutic techniques. Different tools have had varying degrees of success. Some tools may improve some aspects related to applying a particular therapy, while sometimes making other aspects worse. Other tools may fall short of the desired effect, or may be the victim of ever increasing demands that they were never intended to meet and/or address. Consequently, there is an ever increasing demand to develop more effective techniques, some of which may only be possible with an appropriate tool. Furthermore, there is a demand to increase the effectiveness of existing tools.

Several techniques require the targeted application of pressure and/or force. At least a couple of examples include muscle stripping, trigger point, friction, and effleurage. Furthermore, the addition of force to other types of therapies can sometimes improve their effectiveness. However, the persistent application of force can, in some instances, be taxing on a therapist. Consequently, techniques and/or tools, which can assist in the application of force or can more effectively apply an existing force can serve to relieve some of the strain on a therapist, when applying a particular technique.

Furthermore, tools which help combine the effective application of force with other therapies may also be beneficial. Still further, techniques or tools that help to eliminate other impediments to the application of an effective treatment, either to the recipient of the treatment, or the person applying the treatment, would additionally be beneficial.

### SUMMARY OF THE INVENTION

A massage tool is provided which includes a contact element having a first end, which is adapted for engaging a recipient of therapy and a second end at the other end of a length, which extends along a contact axis. The massage tool further includes a leg having a first end, coupled to the second end of the contact element, and having a length which extends away from the contact element and contact axis, and terminates in a second end, which is not in line with the contact axis. The massage tool still further includes a handle having a first end coupled to the second end of the leg, and having a length which terminates in a second end and which extends back toward the contact axis at an angle that is transverse to the contact axis, wherein, when the handle extends back toward the contact axis, the length of the handle extends through the contact axis resulting in a portion of the handle, being located on the opposite side of the contact axis.

In at least one embodiment of the invention, the massage tool further includes a second leg having a first end coupled to the second end of the handle, and having a length which extends back toward the contact axis in a direction away from the contact element and terminates in a second end. The massage tool additionally includes a second contact element having a first end adapted for engaging the recipient of therapy, and a second end coupled to the second end of the second leg at the other end of a length, wherein the length extends along a second contact axis.

In at least a further embodiment of the invention, the massage tool is weighted to increase the overall mass of the massage tool.

In yet a still further embodiment of the invention, the portion of the handle on the opposite side of the contact axis, relative to the position of the leg, has a mass, which counterbalances the mass of the other portion of the handle and the leg, thereby biasing the center of the mass of the massage tool toward the contact axis.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a side view of a massage tool for applying a localized force and/or pressure, in accordance with at least one embodiment of the present invention;

FIG. 2 is a side view of a further embodiment of a massage tool having multiple contact elements for applying a localized force and/or pressure;

FIG. 3 is a partial top view of the wedge type contact element, illustrated in FIG. 2; and

FIG. 4 is a partial top view of the point type contact element, illustrated in FIGS. 1 and 2;

FIG. 5 is a side view of the massage tool illustrated in FIG. 2, shown being gripped by the hand of a user.

### DETAILED DESCRIPTION OF THE PREFERRED EMBODIMENTS

While the present invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

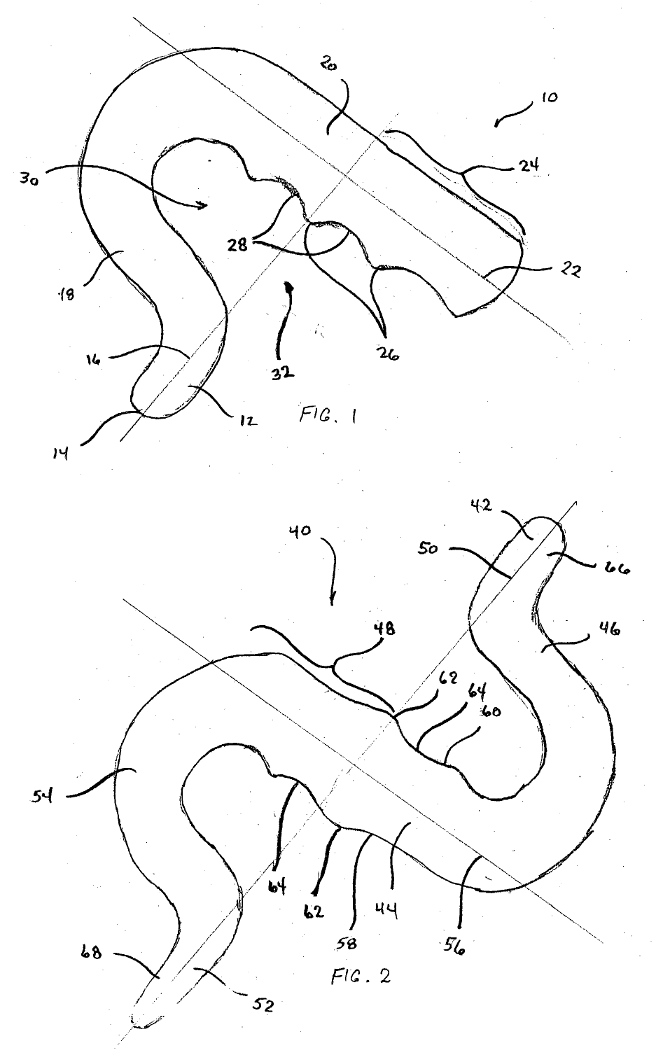

Referring now to the drawings in greater detail, there is illustrated in FIG. 1 a side view of a massage tool 10 for applying a localized force and/or pressure, in accordance with at least one embodiment of the present invention. The massage tool 10 includes a contact element 12, which in the illustrated embodiment takes the form of a point 14. While a point 14 is illustrated, the contact element 12 could alternatively be shaped to take other forms. For example, the contact element 12 could be alternatively shaped as a wedge, an example of which is illustrated in connection with later described embodiments. The contact element 12 defines a contact axis 16, which extends through the proximate center of the contact element 12.

The contact element 12 is coupled to one end of a leg 18, which extends in a direction that diverges away from the contact axis 16. The other end of the leg 18 is coupled to a handle 20, which extends in a direction that travels back toward the contact axis 16 along an axis 22 that transverses the contact axis 16, and includes a portion 24 that extends beyond the contact axis. The portion 24 of the handle 20 has a mass that helps to counter the biasing effects of the mass of the leg 18 relative to the center of mass, which if left unopposed would cause the center of mass to drift away from the proximity of the contact axis 16.

In at least the illustrated embodiment, a substantial portion of the mass is largely comprised of one or more base materials used to form the various elements of the massage tool. In at least one embodiment the base material is comprised of iron. However one skilled in the art will readily appreciate that other materials could be used. Alternatively hooks or inserts could be used to attach supplemental mass in the form of weights. In the illustrated embodiment, the overall mass of the tool is approximately 1.5 pounds, but can vary. One possible weight range includes an overall weight as low as twelve ounces, and an overall weight as high as six pounds or more.

In at least one embodiment, the one or more base materials are coated with a layer of plastic, or other smooth non-abrasive material, such as a plastic sold under the trade name Plastisol by Vynaflex Co. In addition to providing a smooth surface, the coating can provide insulative characteristics, that reduces the conduction of heat. Additionally, the coating can act as a barrier against rust in the materials forming at least a part of the base materials. Still further, the plastic when applied can readily adapt to shapes and sizes, which might vary.

In the illustrated embodiment, the surface of the handle facing toward the contact element includes a plurality of ridges 26 and valleys 28. The ridges 26 and valleys 28 provide a contoured surface, which can more readily accommodate receipt of the user's fingers. Between the surface of the handle facing toward the contact element 12 and the leg 18 is a space 30, which is open at one end 32. The space 30 is sized and spaced to receive the hand and/or fingers of a user. The open end 32 of the space 30 serves to accommodate hands of varying sizes.

The orientation of the handle relative to the contact axis, enables the massage tool to be gripped in a fashion, where the contact axis proximately extends along the arm of the user. This allows any force supplied and/or supported by the user to come from the arm of the user, as opposed to needing to be largely generated and/or supported by the user's wrist.

FIG. 2 illustrates a side view of a further embodiment of a massage tool 40 for applying a localized force and/or pressure. Similar to the embodiment illustrated in FIG. 1, the massage tool 40 includes a first contact element 42, which is coupled to a handle 44, via a first arm 46. However, instead of terminating at the portion 48 of the handle 44, which extends through the contact axis 50, the handle 44 is coupled to a second contact element 52, via a second arm 54.

In this instance the mass of the first arm 46 can be counterbalanced by the mass of the second arm 54, thereby making maintaining a center of mass proximate the contact axis 50 a little more straight forward, as the size and shape of the embodiment illustrated in FIG. 2 is a little more symmetrical. The embodiment illustrated in FIG. 2 has a weight of approximately two and a half pounds. However, similar to the first embodiment, the desired weight can be tailored to more readily accommodate other forms of therapies. In some instances the weight of the massage tool will be sufficient to produce the desired pressure, thereby enabling the user to more readily focus on placement and positioning. Alternatively, the pressure produced by the tool can be supplemented with an exerted force. Even where the weight of the tool is deemed insufficient for producing the desired pressure, the weight of the tool can have the effect of providing at least a portion of the desired pressure, thereby reducing the amount of force that needs to be applied by the user.

The embodiment illustrated in FIG. 2 continues to feature a handle 44, that extends in a direction 56 that is transverse to the contact axis 50. However in the embodiment illustrated in FIG. 2, a second surface 58 of the handle 44, in addition to a first surface 60 of the handle 44, is provided with a plurality of ridges 62 and valleys 64 for accommodating the receipt of the user's fingers, when the tool is oriented for using the second contact element.

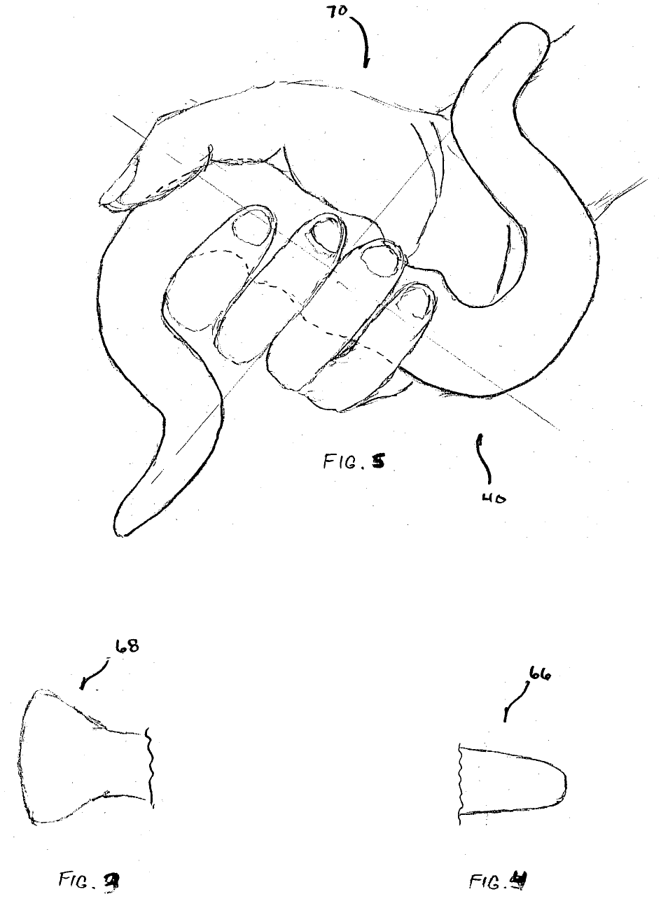

At least one aspect, where the massage tool 40 is not symmetrical, includes the use of two different types of contact elements. In the illustrated embodiment, the first contact element is in the shape of a point 66, while the second contact element is in the shape of a wedge 68. The presence of two types of contact elements in the same tool enables the tool 40 to be used for a wider variety of therapeutic techniques. Generally, the point 66 is meant to mimic a human thumb, and is well suited for providing trigger point therapy, and the wedge 68 is in the shape of a paddle, which tends to be flatter and wider, and which is well suited for providing cross fiber friction, muscle stripping, as well as other therapeutic techniques. At least one exemplary wedge 68 type contact element is further illustrated in FIG. 3, as well as being further described in Louis, U.S. Pat. No. 6,267,738, the disclosure of which is incorporated herein by reference. At least one exemplary point 66 type contact element is further illustrated in FIG. 4, as well as being further described in Louis, '738.

One skilled in the art will readily appreciate that the contact element can take other possible forms and/or different combinations could be combined in each of the pair of respective ends.

In embodiments having multiple contact elements, the corresponding contact axes can be arranged so as to be parallel to one another. In the illustrated embodiment, both of the contact elements 42 and 52 share the same contact axis 50 and/or are co-located.

FIG. 5 is a side view of the massage tool 40 illustrated in FIG. 2, shown being gripped by the hand 70 of a user. As shown, even when one of the ends is not being applied to a recipient of therapy, depending on how the tool is held, the unused end can be used as a brace against the wrist of the user, thereby providing further support. Furthermore, as can be more readily seen in FIG. 5, by orienting the axis through which the handle extends, so as to be transverse with respect to the contact axis, the contact axis can be more closely aligned with the user's arm. This allows the force generated through the user's arm to be more directly received by the massage tool, and applied to the recipient of the therapy.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A massage tool comprising:
a contact element having a first end adapted for engaging a recipient of therapy and a second end at the other end of a length, which extends along a contact axis;
a leg having a first end, coupled to the second end of the contact element, and having a length which extends away from the contact element and contact axis, and terminates in a second end, which is not in line with the contact axis; and
a handle having a first end coupled to the second end of the leg, and having a length which terminates in a second end and which extends back toward the contact axis at an angle that is transverse to the contact axis; and
wherein, when the handle extends back toward the contact axis, the length of the handle extends through the contact axis resulting in a portion of the handle, which is located on the opposite side of the contact axis.

2. A massage tool in accordance with claim 1 wherein the portion of the handle on the opposite side of the contact axis, relative to the position of the leg, has a mass, which counterbalances the mass of the other portion of the handle and the leg, thereby biasing the center of the mass of the massage tool toward the contact axis.

3. A massage tool in accordance with claim 2 wherein the amount of mass of the portion of the handle on the opposite side of the contact axis, relative to the position of the leg, is sufficient to align the center of mass of the massage tool with the contact axis.

4. A massage tool in accordance with claim 1 wherein the first end of the contact element is a point.

5. A massage tool in accordance with claim 1 wherein the first end of the contact element is a wedge.

6. A massage tool in accordance with claim 1 wherein the massage tool is weighted to increase the overall mass of the massage tool.

7. A massage tool in accordance with claim 6 wherein the additional mass is integrated in the overall structure of the massage tool.

8. A massage tool in accordance with claim 1 wherein the massage tool includes one or more base materials with a non-abrasive coating.

9. A massage tool in accordance with claim 1 wherein the handle has a surface that faces toward the contact element, which includes a plurality of ridges and valleys, which are sized and shaped such that the valleys are adapted to receive the fingers of a user.

10. A massage tool in accordance with claim I further comprising:
a second leg having a first end coupled to the second end of the handle, and having a length which extends back toward the contact axis in a direction away from the contact element and terminates in a second end; and
a second contact element having a first end adapted for engaging the recipient of therapy, and a second end coupled to the second end of the second leg at the other end of a length, wherein the length extends along a second contact axis.

11. A massage tool in accordance with claim 10 wherein the second contact axis is substantially parallel to the first contact axis.

12. A massage tool in accordance with claim 10 wherein the second contact axis is co-located with the first contact axis.

13. A massage tool in accordance with claim 10 wherein the first end of the contact element is a point and the first end of the second contact element is a wedge.

14. A massage tool in accordance with claim 10 wherein the massage tool is weighted to increase the overall mass of the massage tool.

15. A massage tool in accordance with claim 10 wherein the handle has a surface facing toward the contact element and a surface facing toward the second contact element, wherein each of the surfaces facing toward one of the contact elements includes a plurality of ridges and valleys, wherein the valleys are sized and shaped such that the valleys are adapted to selectively receive the fingers of a user, when the valleys are part of the surface facing toward the one of the first end of the contact element and the first end of the second contact element being used to currently engage a recipient of therapy.

16. A massage tool in accordance with claim 10 wherein each leg extends back toward the contact axis a distance away from the handle to provide sufficient space for receipt of the hand of the user.

17. A massage tool in accordance with claim 10 wherein each leg extends back toward the contact axis whereby the leg is adapted to wrap around the back of the hand of the user.
